(19) United States
(12) Patent Application Publication
(10) Pub. No.: US 2016/0379387 A1
(43) Pub. Date: Dec. 29, 2016

(54) METHOD FOR SYNCHRONIZED MEASUREMENTS FOR A PORTABLE MULTI-CHANNEL WIRELESS SENSOR SYSTEM

(71) Applicant: David Allen Stanley, San Diego, CA (US)

(72) Inventor: David Allen Stanley, San Diego, CA (US)

(73) Assignee: AKTIEBOLAGET SKF, GOTEBORG (SE)

(21) Appl. No.: 14/749,197

(22) Filed: Jun. 24, 2015

(51) Int. Cl. G06T 11/20; G01M 99/00

(52) U.S. Cl. CPC G06T 11/206; G01M 99/005

(57) ABSTRACT

A method for monitoring a machine is provided. The method includes obtaining a graphical representation of the machine, wherein the machine comprises a shaft and a bearing supporting the shaft; obtaining one or more displacement data representative of a position of the shaft relative to the bearing at one or more time periods from a pair of displacement sensor coupled to the bearing; and causing a processor to display the graphical representation of the machine on a computer display supplemented by the one or more displacement data.

### BACKGROUND

The present disclosure relates to the field of monitoring moving components of a machine. More particularly, the present disclosure relates to a system for modeling and visualizing the position and vibration of a rotating shaft using signals from synchronized radial displacement probes located at multiple bearing locations along the shaft.

When a shaft is rotating at its nominal operating speed, the shaft usually rides on a hydrodynamic wedge of oil between the bearing and the shaft. If the shaft develops an abnormal vibrational mode while rotating, the outer surface of the shaft may contact the inner surface of the bearing and cause damage to the shaft and the bearing. To avoid such situations, it is important for operational personnel to be able to monitor the position of a rotating shaft with respect to the surfaces of the sleeve bearings in which it rotates.

What is needed, therefore, is a tool for providing a visual depiction of a shaft rotating within multiple sleeve bearings, which depiction indicates the relative spacing between the outer surface of the shaft and the inner surfaces of the bearings and indicates the average center line of the shaft at each bearing location.

### SUMMARY

In accordance with aspects consistent with the present teachings, a method for monitoring a machine is provided. The method can comprise obtaining a graphical representation of the machine, wherein the machine comprises a shaft and a bearing supporting the shaft; obtaining one or more displacement data representative of a position of the shaft relative to the bearing at one or more time periods from a pair of displacement sensor coupled to the bearing; and causing a processor to display the graphical representation of the machine on a computer display supplemented by the one or more displacement data.

In some aspects, the method can further comprise obtaining one or more speed data representative of a speed at which the shaft is rotating from a speed sensor coupled to the bearing; and causing the processor to display the graphical representation of the machine on the computer display supplemented by the one or more speed data.

In some aspects, the method can further comprise creating the graphical representation of the machine.

In some aspects, the method can further comprise determining one or more additional metric data based on the one or more displacement data.

In some aspects, the one or more additional metric data can comprise one or more of: speed data, acceleration data, harmonic data, and combinations thereof.

In some aspects, the method can further comprise creating an orbital plot for the shaft based on the one or more displacement data.

In some aspects, the method can further comprise determining that the one or more displacement data is outside of a threshold value; and causing the processor to display an alarm based on the determining.

In some aspects, the method can further comprise determining oil whip, oil whirl, or both due to presence of oil within the bearing; causing the processor to display the oil whip, oil whirl, or both.

In accordance with aspects consistent with the present teachings, a method for monitoring a shaft in a bearing is provided. The method can comprise obtaining a graphical representation of a shaft and a bearing supporting the shaft; obtaining one or more performance metric data one or more time periods from a pair of displacement sensor and a tachometer sensor coupled to the bearing; and causing a processor to display the graphical representation of the shaft and the bearing on a computer display supplemented by the one or more performance metric data.

In some aspects, the method can further comprise obtaining one or more speed data representative of a speed at which the shaft is rotating from the tachometer sensor; and causing the processor to display the graphical representation of the shaft and the bearing on the computer display supplemented by the one or more speed data.

In some aspects, the method can further comprise creating the graphical representation of the shaft and the bearing.

In some aspects, the one or more performance metric data comprises one or more of: displacement data representative of a position of the shaft relative to the bearing at the one or more time periods; speed data, acceleration data, harmonic data, and combinations thereof.

In some aspects, the method can further comprise determining one or more performance metric data based on the one or more displacement data.

In some aspects, the method can further comprise creating an orbital plot for the shaft based on the one or more displacement data.

In some aspects, the method can further comprise determining that the one or more displacement data is outside of a threshold value; and causing the processor to display an alarm based on the determining.

In some aspects, the method can further comprise determining oil whip, oil whirl, or both due to presence of oil within the bearing; causing the processor to display the oil whip, oil whirl, or both.

### BRIEF DESCRIPTION OF THE DRAWINGS

The accompanying drawings, which are incorporated in and constitutes a part of this specification, illustrates an embodiment of the present teachings and together with the description, serves to explain the principles of the present teachings. In the figures:

FIG. 1 depicts an example system for modeling shaft vibration, according to an embodiment.

FIG. 2 depicts an example shaft disposed with bearings and orthogonally positioned displacement probes, according to an embodiment.

FIG. 3 depicts an example method for modeling shaft vibrations, according to an embodiment.

FIG. 4 depicts an example orbital plot for a shaft, according to an embodiment.

FIG. 5 depicts an example graphical representation of a shaft/bearing assembly with supplemental data, according to an embodiment.

FIG. 6 depicts an example graphical representation of a shaft/bearing assembly with supplemental data, according to an embodiment.

FIG. 7 depicts an example graphical representation of a shaft/bearing assembly with supplemental data, according to an embodiment.

It should be noted that some details of the figures have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawings. In the drawings, like reference numerals have been used throughout to designate identical elements, where convenient. In the following description, reference is made to the accompanying drawings that form a part of the description, and in which is shown by way of illustration one or more specific example embodiments in which the present teachings may be practiced.

Further, notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

Generally speaking, aspects consistent with the present disclosure provide the ability to visualize static and dynamic behavior of a shaft or rotor in a one or more bearing ring assembly. The embodiments provide for visualization of relative motions between rotor and bearings at one or more locations along the centerline, and interpretation of these aspects in comparison with a variety of parameters, including vibration frequency of the shaft/bearing assembly, turning speed of the shaft, i.e., one times turning speed (1×RPM), two times turning speed (2×RPM), etc.). The visualization of the shaft along the length of the shaft allows a more controlled visualization of the machine. The visualization is supplemented with additional information that can provide an explanation and interpretation for some peculiarities or other anomalies which come to the attention of a vibration analyst or other interested parties. Embodiments of the present disclosure described herein also aid an operator in discerning, either automatically or by user interpretation, between different harmonic vibration conditions, such as 1×RPM, and 2×RPM, etc. anomalies that can be of interest to the operator, and thereby derive an understanding of the cause of an anomalous condition.

Embodiments described herein use program logic to compute relative phase, amplitude, and/or periodicity of the movement of a shaft centerline relative to a bearing or other stationary structure. The program logic interprets this information, and displays a graphical image interpretation using highlighting or color differences or exaggerated displacement. In this way, the program logic provides visual information displayed with a shaft centerline plot to assist an operator in discerning between different anomalous conditions.

Embodiments described herein are useful in visualizing various resonances as a shaft turns at different speeds. A shaft can sometimes pass through a rigid body first critical resonance as it runs up to speed. Some shafts negotiate second, third, or even higher order critical resonances as they proceed to operating speed. Typically this is an expected dynamic condition. As such, each critical resonance or other known resonance is cautiously negotiated by the operator responsible for running a rotor up to operating speed. Various embodiments described herein assist the operator in seeing dynamic rotation, bearing clearances, and anomalous motions as a function of running speed. With such visualization information, an operator is better able to avoid destructive actions that are common in startup and shutdown of rotating machinery such as turbine rotors.

Additionally, there are many operating speed dependent faults, such as oil whirl, oil whip, and other dynamic functioning machine conditions that are characteristic to a specific machine or process. Like resonance, these other speed dependent faults may be better avoided using a shaft centerline visualization technique as provided by the various embodiments described herein.

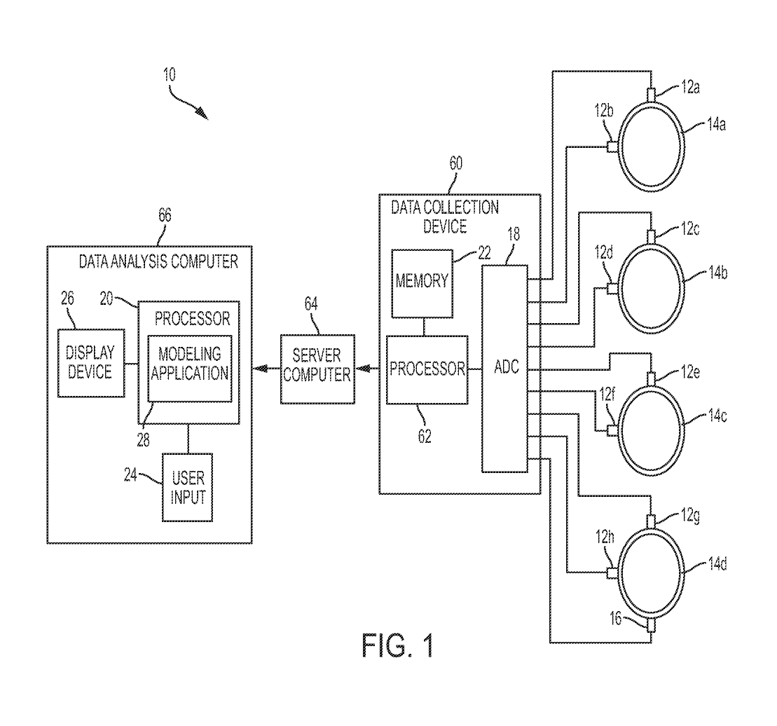

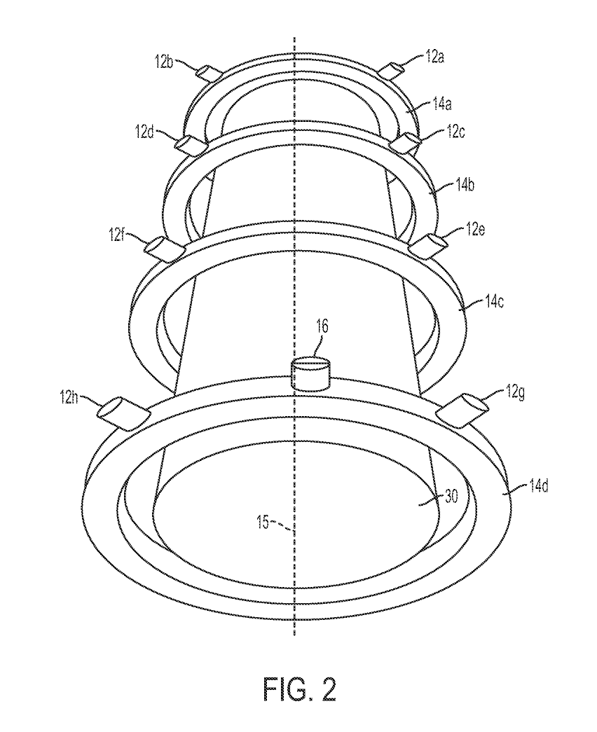

FIG. 1 shows an example system 10 for modeling displacement and vibration of a shaft 30 rotating about a rotational axis 15, according to embodiments. The system 10 includes pairs of displacement sensors 12a-12b, 12c-12d, 12e-12f, and 12g-12h attached to sleeve bearings 14a, 14b, 14c and 14d. FIG. 2 shows an example perspective view of the shaft 30, displacement sensors 12a-12b, 12c-12d, 12e-12f, and 12g-12h attached to sleeve bearings 14a, 14b, 14c and 14d. These sensors are disposed on displacement axes that are referred to herein as the x-axis (horizontal axis) and y-axis (vertical axis). In one embodiment, all of the y-axis sensors (12a, 12c, 12e and 12g) are aligned with each other, and all of the x-axis sensors (12b, 12d, 12f and 12h) are aligned with each other, so that the output signals are rotationally synchronized. These displacement sensors may also be referred to herein as proximity sensors, proximity probes, proximity transducers, displacement transducers, or displacement probes. In one embodiment, the displacement sensors are non-contact eddy current transducers which provide a voltage output signal that is proportional to the distance between the tip of the transducer and the surface of the shaft 30. Examples of such sensors are model number PR 6423 manufactured by Epro GmbH and model number VK-452A manufactured by Shinkawa Sensor Technology, Inc.

In some embodiments described herein, the two displacement sensors in each pair are oriented at 90 degrees with respect to each other. However, it will be appreciated that the sensors may be oriented at other angles, so long as the angle is known.

The system 10 also includes a tachometer sensor 16 that is arranged orthogonal to the rotational axis 15, which generates an output signal indicating the rotational speed of the shaft. In some embodiments, since the rotational speed of the shaft tends to be the same at all of the bearing locations, one tachometer sensor may perform the processes described herein, although additional tachometers might be used (e.g., for redundancy). In some embodiments, if there are multiple shafts connected by gears in the system, then the shafts will be rotating at speeds proportional to the ratio of the gear teeth. For example, if one shaft has a tachometer that measures 100 RPM and there is a gear on that shaft with 10 teeth connected to another gear with 5 teeth connection to another shaft, then the another shaft will rotate at 200 RPM.

The outputs of the displacement sensors 12a-12h and the tachometer sensor 16 are electrically connected to the inputs of an analog-to-digital converter (ADC) 18 of a data collection device 60, such as the CSI 4500 or CSI 6500 Machinery Health® Monitor manufactured by Emerson Process Management. The ADC 18 can have a 24-bit resolution, greater than 100 dB dynamic range, and samples the sensor output voltages at a rate of 5120 samples per second. The digital displacement signal data and tachometer signal data at the output of the ADC 18 are provided to a processor 62 of the data collection device 60 which maintains the data in memory 22 until it is downloaded for analysis.

In some embodiments, the data collection device 60 is in communication with a server computer 64 on which the data from the sensors 12a-12h are occasionally archived in long-term storage for subsequent analysis. In some embodiments, the server computer 64 communicates with the data collection device 60 via a communication network, such as an Ethernet network, Wi-Fi network, or Virtual Private Network. In other embodiments, the data collection device 60 may connect directly to the server computer 64 via a USB serial link or other data link.

As shown in FIG. 1, a data analysis computer 66 is in communication with the server computer 64 via a communication network, such as an Ethernet network, Wi-Fi network, or Virtual Private Network. The data analysis computer 66 may be a personal computer, a server, a laptop, or tablet computer. The data analysis computer 66 includes a processor 20 operable to execute instructions of a modeling software application 28 as described in more detail hereinafter. The data analysis computer 66 also can include a user input device 24, such as a keyboard, mouse, touchpad or touchscreen, and a display device 26.

The output signal from each displacement probe can be represented as a DC component and an AC component. The DC component represents the average shaft position relative to the corresponding displacement sensor and the AC component represents the absolute shaft position relative to the corresponding displacement sensor. In physical terms, for each single rotation of the shaft, it has an average center position (DC component) and an absolute center position (AC component) oscillating about the average center position.

To determine an actual shaft position relative to any of the pairs of sensors, the voltages produced by the pair of sensors when the shaft is stationary or turning very slowly are needed. This is referred to as a sensor's resting voltage and is one of the setup values used in the graphing process described herein. The resting voltage is subtracted from a measured voltage to determine the change in the shaft position compared to its resting state. This change in position typically involves the shaft lifting off the bottom surface of the bearing and becoming supported by a hydrodynamic wedge of oil as the shaft's rotational speed increases. In some embodiments, the displacement sensors can be augmented with additional sensor types, i.e., accelerometers, velometers, temperature, etc.

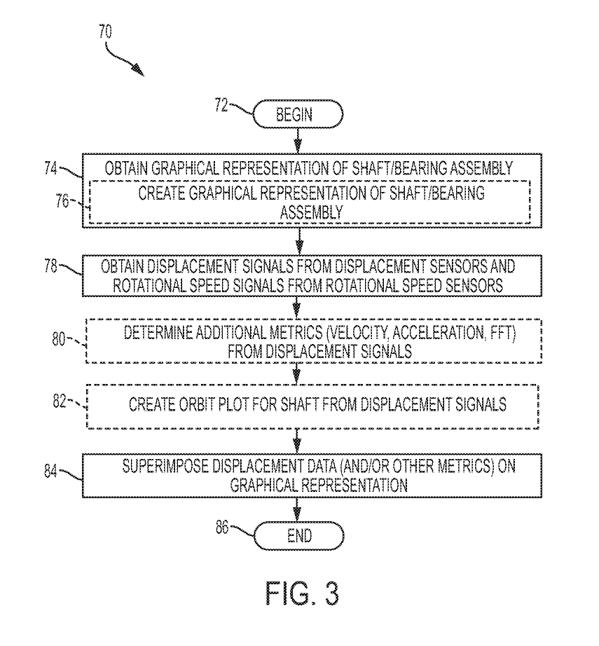

Embodiments of the present disclosure use data similar to that depicted in FIG. 1 for a single bearing location to construct a 3-dimensional model showing dynamic motion of a shaft center around an average shaft center position at multiple bearing locations along a rotating shaft. This 3-dimensional model is constructed by the modeling application 28 that performs data collection, analysis and graphing functions as shown in FIG. 3.

As shown in FIG. 3, a modeling process 70 begins at 72. At 74, a graphical representation of a shaft/bearing assembly is obtained. The graphical representation can be a wireframe model and can be stored among other shaft/bearing arrangements in the modeling application 28. Other types of graphical representations can be used as are known in the art. Alternatively, a graphical representation can be created at 76 using software tools in the modeling application 28 that are known in the art. At 78, shaft displacement data is obtained in two axes from the displacement probes 12a-12h at one or more of the four bearings 14a-14d over a time period. As discussed above, this data may be collected using the data collection device 60. Tachometer data from the tachometer 16 is also collected over the time period. The displacement data and tachometer data can be transferred to the server computer 64 where they can be archived until subsequent graphing and animation steps are performed. Alternatively, as discussed in more detail hereinafter, the graphing and animation steps may be performed substantially in real-time based on the displacement data and tachometer data.

Using the data analysis computer 66, a user executes the modeling application 28 which comprises computer-executable instructions for performing some or all of the following steps. In one embodiment, the user first selects a data archive of interest stored on the server computer for analysis using the user input device 24. In an alternative embodiment discussed hereinafter, the user may choose to model data collected in real-time. As the term is used herein, a data archive is a group of related transient waveform data sets (x-y displacement data as a function of time). The waveform data and the setup data (probe resting voltages and bearing clearance) for the selected archive are then transferred to the data analysis computer 66 from the server computer 64. The modeling application 28 then can determine additional metric data from the displacement and/or rotational speed data, such as magnitude and direction of the angular velocity, angular acceleration, oil whirl, oil whip, or any combinations thereof, which can then be displayed with the graphical representation of the shaft/bearing assembly at 80. The modeling application 28 can be operable to perform fast Fourier transforms (“FFT”) or discrete Fourier transform (“DFT”) on any of the measured data types, which can be used to calculate the velocity, acceleration, or other relevant parameters that may interest the user by using full spectrum algorithms that are known in the art. For example, input to the DFT calculation can include a real input and an imaginary input. For a normal spectrum calculation, the time waveform data from one displacement sensor is used as the real input and an array of zeros is used for the imaginary input. For full spectrum calculation, the time waveform data from one displacement sensor is used as the read input and the time waveform data from the other displacement sensor from the displacement sensor pair is used as the imaginary input. To calculate/identify vibrations that run counter to the rotation of the shaft, i.e., oil whip/whirl, both sets of time waveform data are used in the same calculation. The full spectrum algorithms can be used to calculate forward rotations forces and reverse rotational forces (oil whip/oil whirl), which can be displayed. The difference between oil whirl and oil whip is that the frequency of oil whirl is about 48% of the running speed of the shaft and therefore, changes with the running speed. When the shaft/bearing system goes through a resonance, oil whip can occur. The frequency of the oil whip tends to stay nearly constant regardless of increasing speed.

In some embodiments, the modeling application 28 can be operable to generate and display as arrows representative of forces for a variety of conditions associated with the shaft and bearings including, but are not limited to, shaft imbalance, mechanical looseness (such as the foot of the machine is not securely fastened to the floor), misalignment, gear teeth meshing, cracked fan blades, fan belt that is too tight or too loose, bearing problems (inner/outer race, damage to the bearing, cage), rotor rub, resonance, cavitation, etc.

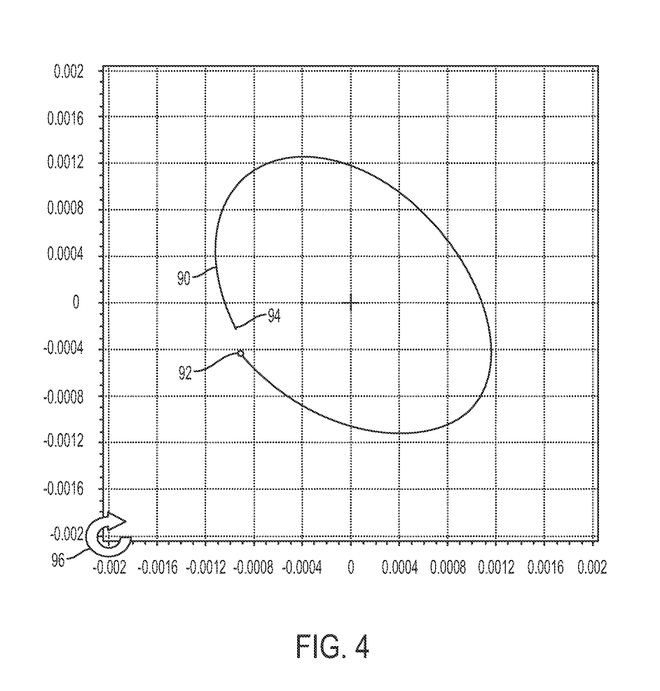

Also, the modeling application can optionally create one or more orbit plots of the shaft displacement within the bearing at one or more locations of the displacement sensors at 82. FIG. 4 shows an example orbit plot 90 beginning at position 92 and ending at position 94 for a single rotation period of the shaft. The plot 90 is created with a first displacement sensor (displacement sensor Y) at the 10 o'clock position on the rotor and the second displacement sensor (displacement sensor X) at the 2 o'clock position on the rotor, the shaft rotating in a clockwise manner, as indicated by arrow 96, and processed by the data analysis computer 66. The orbital plots can show an average shaft centerline position and dynamic shaft centerline movement around the average shaft centerline for each of the bearing positions (designated b=1 to b=4) for multiple time ranges over the time period covered in the selected data archive. The modeling application 28 can also be operable to calculate phase information using data from the displacement sensors, oriented orthogonal to each other in the same plane, and the tachometer sensor to determine the difference between two vibrations. As noted previously, the use of four bearings in this example is completely arbitrary. More or fewer bearings may be modeled using embodiments of the present disclosure. At 84, one or more of the calculated metric data, i.e., displacement, angular velocity, angular acceleration, oil whirl, oil whip, can be superimposed onto the graphical representation of the shaft/bearing assembly. At 86, the method can end.

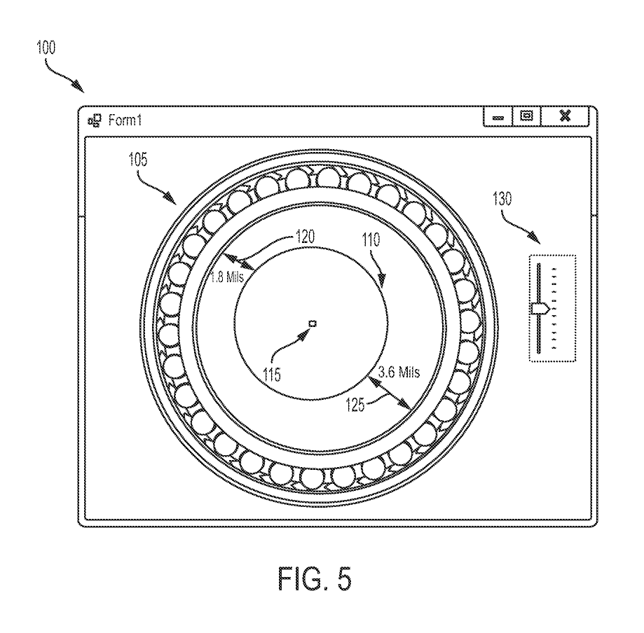

FIG. 5 shows an example of a graphical representation 100 of a shaft/bearing assembly 105 supplemented with shaft displacement measurements for a particular time interval as measured by a pair of displacement sensors, such as displacement sensors 12a and 12b, and processed by the data analysis computer 66. As shown in FIG. 5, the center of the shaft is represented by the dot 115 at start up or during a low RPM period, which is also called “slow roll.” During this measurement period, the shaft 110 is displaced from the bearing 105 by 1.8 mils at position 120 and the shaft 110 is displaced from the bearing 105 by 3.6 mils at position 125. This supplemental information can be displayed in a variety of manners. For example, as the user moves the mouse pointer for an area of interest and leaves the mouse pointer stationary, the supplemental information can be provided to the user as “hover text” or text that appears once the mouse pointer has stopped moving. Alternatively, the supplemental information can be provided in a separate pop-up window when the user clicks the mouse at a particular area where the supplemental information is available, as is known in the art. Other mechanism of providing the supplemental information over graphical data that is viewable to the user can be used as are known in the art. Also, the manner and type of supplemental information that is display can be customizable, as is known in the art. A slider 130 can be provided in the graphical representation 100 that can be used by the user to change the graphical representation in time or with respect to other parameters, such as orders of magnitude of the RPM, angular velocity, or angular acceleration. Additional sliders (not shown) can also be provided to show other parameters that may be of interest. For example, two sliders may be provided that allows the user to change the time interval being viewed, as well as, the frequency at which the shaft/bearing is vibrating. The frequency can be expressed as either Hertz (Hz—cycles/second), revolutions per minute, or orders of running speed (1×, 2×, etc.). For example, if the shaft is turning at 100 RPM, its frequency in Hz is 600 revolutions/minute*1 minute/60 second=10 Hz. The 1× would also be 10 Hz. The 2× would be 20 Hz, and so on. Other combination of parameters can also be used.

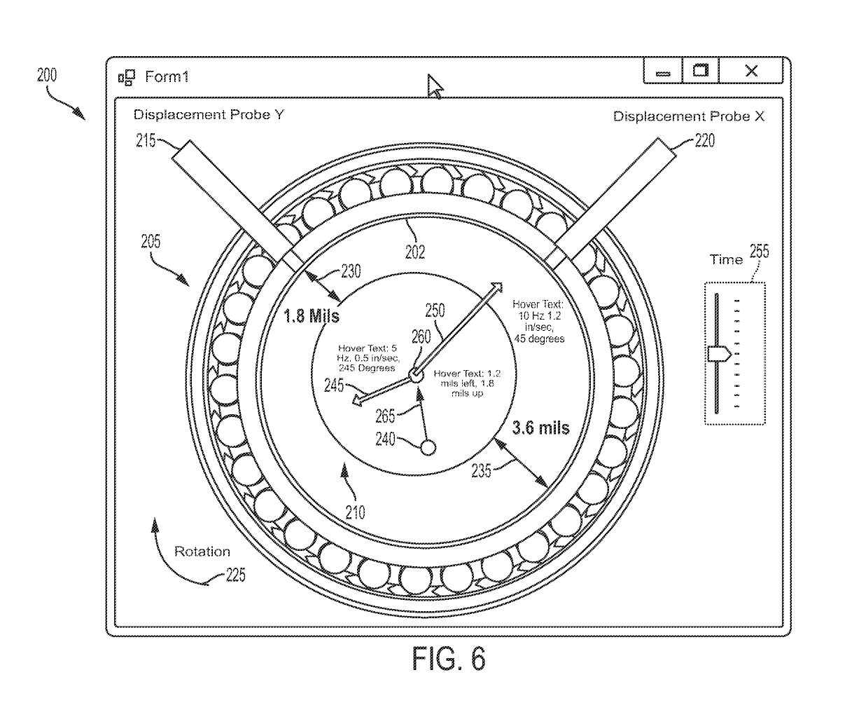

FIG. 6 shows an example of a graphical representation 200 of a shaft/bearing assembly 205 supplemented with shaft displacement and shaft angular velocity measurements for a particular time interval as measured by a pair of displacement sensors 215 (displacement probe Y) located at the 10 o'clock position relative to the bearing 202 and 220 (displacement probe X) located at the 2 o'clock position relative to the bearing 302, such as displacement sensors 12a and 12b, and processed by the data analysis computer 66. In this example, the shaft 210 is rotating in a clockwise manner, as indicated by arrow 225. As shown in FIG. 6, the shaft 210 is displaced from the bearing 202 by 1.8 mils at position 230 and the shaft 210 is displaced from the bearing 202 by 3.6 mils at position 235. As the shaft 210 rotates, the center of the shaft 210 moves from position 240 at rest or at low RPM (“slow roll”) to position 260 in the direction of arrow 225. The velocity at which the shaft 210 moves during different operating RPMs and at different frequencies of vibration of the shaft/bearing assembly 205 can be included in the graphical representation 200. In this example, arrow 245 shows both the magnitude and direction at which the shaft is moving at one particular operating condition. As shown for one frequency of vibration, the shaft 210 is moving at 0.5 inches/second at 245 degrees at 5 Hz of vibration. Also, for another frequency of vibration, the shaft 210 is moving at 1.2 inches/second at 45 degrees at 10 Hz of vibration. Further, one or more forces exerted on the shaft 210 can also be included in the graphical representation 200. This supplemental information can be displayed in a variety of manners as discussed above in FIG. 5. A slider 255 can be provided in the graphical representation 200 that can be used by the user to change the graphical representation in time, or with respect to other parameters, such as orders of magnitude of the RPM, angular acceleration, and frequency of vibration. In this example, as the slider 255 is moved in time, the position of the center of the shaft 210 will change from position 240 to position 260 as time progress. Also, the other supplemental information will change as well for the particular time interval being viewed.

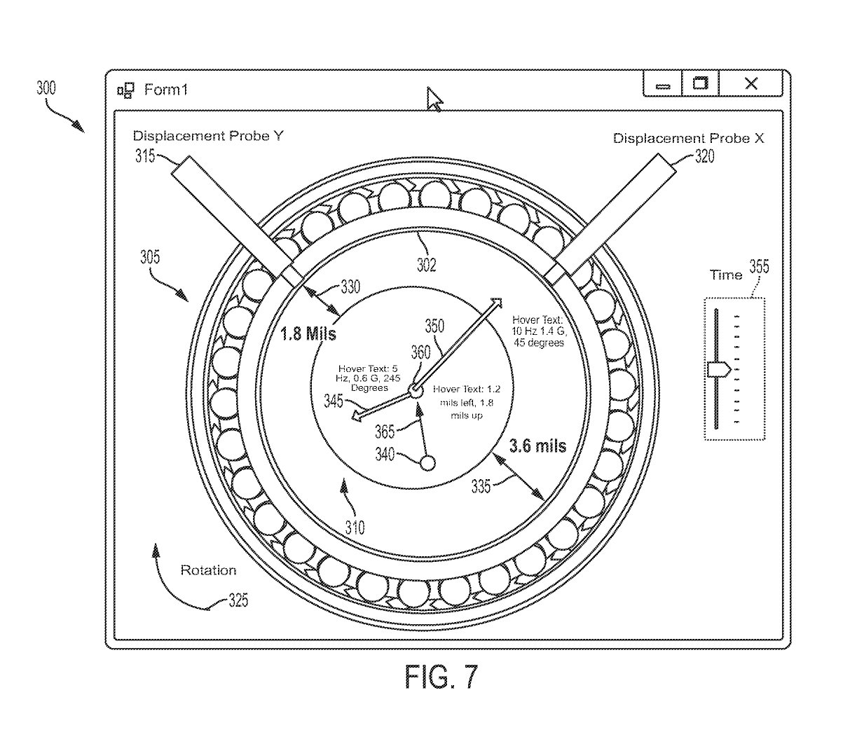

FIG. 7 shows an example of a graphical representation 300 of a shaft/bearing assembly 305 supplemented with shaft displacement and shaft angular acceleration measurements for a particular time interval as measured by a pair of displacement sensors 315 (displacement probe Y) located at the 10 o'clock position relative to the bearing 302 and 320 (displacement probe X) located at the 2 o'clock position relative to the bearing 302, such as displacement sensors 12a and 12b, and processed by the data analysis computer 66. In this example, the shaft 310 is rotating in a clockwise manner, as indicated by arrow 325. As shown in FIG. 7, the shaft 310 is displaced from the bearing 302 by 1.8 mils at position 330 and the shaft 310 is displaced from the bearing 302 by 3.6 mils at position 335. As the shaft 310 rotates, the center of the shaft 310 moves from position 340 at rest or at low RPM (“slow roll”) to position 360 in the direction of arrow 365. The acceleration at which the shaft 310 moves during different operating RPMs and at different frequencies of vibration of the shaft/bearing assembly 305 can be included in the graphical representation 300. In this example, arrow 345 shows both the magnitude and direction at which the shaft is accelerating at one particular operating condition. As shown for one frequency of vibration, the shaft 310 is accelerating at 0.6 Gs at 245 degrees at 5 Hz of vibration. Also, for another frequency of vibration, the shaft 310 is accelerating at 1.4 Gs at 45 degrees at 10 Hz of vibration. Further, one or more forces exerted on the shaft 310 can also be included in the graphical representation 300. This supplemental information can be displayed in a variety of manners as discussed above in FIG. 5. A slider 355 can be provided in the graphical representation 300 that can be used by the user to change the graphical representation in time, or with respect to other parameters, such as orders of magnitude of the RPM, angular velocity, and frequency of vibration. In this example, as the slider 355 is moved in time, the position of the center of the shaft 310 will change from location 340 to location 360 as time progress. Also, the other supplemental information will change as well for the particular time interval being viewed.

In some embodiments, the user may also be allowed to configure overall vibrational values to be displayed as well (via a popup menu). These overall values/arrows would be a vector summation of all the vibrational forces (arrows). The user may not be interested in all the arrows pointing in different directions, they may wish to see all of them added together as just one arrow pointing in one direction.

In some embodiments, alarms (not shown) can be added to the views of FIG. 5-7, such that when an anomalous event occurs, the user can be alerted so that various mitigation steps may be performed. For example, if the shaft 110, 210, 310 during a transient condition, i.e., start up or sudden change of speed, where to move in an unexpected manner, an alarm can be provided on the graphical representation 100, 200, 300 to alert the operator so that the operation may employ one or more mitigating procedures, such as changing the speed at which the shaft is rotating.

Thus, the model 74 helps the user visualize whether the rotating shaft is about to contact a stationary element (bearing surface) in the radial direction. It also helps the user visualize whether the shaft is running in the appropriate region of its supporting bearings. With reference again to FIG. 3, the modeling application 28 repeats the process of constructing a 2-dimensional graph of average shaft centerline and dynamic shaft position for each of the four bearing positions. The user may select an option to animate the model 74, which causes the modeling application 28 to sequentially “play” the individual models 74 constructed for each time period (step 126).

In some embodiments, the modeling application 28 is executed on the processor 20 of the data analysis computer 66. However, it will be appreciated that the modeling application could be executed on the processor 62 of the data collection device 60, on a processor in the server 64, or on any other processor having access to the displacement data. Thus, the present disclosure is not limited to executing the modeling application 28 on any particular computer processor.

As described above, in some embodiments of the present disclosure, the modeling application operates on displacement data stored in a data archive. In alternative embodiments, the operations described above may be performed in real-time or “quasi real-time” as displacement data is collected from the displacement probes. The term “quasi real-time” as used herein indicates that data may be buffered in memory for a very short time between the time of data collection and the time of execution of the graphic modeling steps which generate the 3-dimensional model. This buffer memory may be implemented in the data collection device 60, in the server computer 64 or in the data analysis computer 66.

While the present teachings have been illustrated with respect to one or more implementations, alterations and/or modifications may be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A method for monitoring a machine, comprising:
obtaining a graphical representation of the machine, wherein the machine comprises a shaft and a bearing supporting the shaft;
obtaining one or more displacement data representative of a position of the shaft relative to the bearing at one or more time periods from a pair of displacement sensor coupled to the bearing; and
causing a processor to display the graphical representation of the machine on a computer display supplemented by the one or more displacement data.

2. The method of claim 1, further comprising:
obtaining one or more speed data representative of a speed at which the shaft is rotating from a speed sensor coupled to the bearing; and
causing the processor to display the graphical representation of the machine on the computer display supplemented by the one or more speed data.

3. The method of claim 1, further comprising creating the graphical representation of the machine.

4. The method of claim 1, further comprising determining one or more additional metric data based on the one or more displacement data.

5. The method of claim 4, wherein the one or more additional metric data comprises one or more of: speed data, acceleration data, harmonic data, and combinations thereof.

6. The method of claim 1, further comprising creating an orbital plot for the shaft based on the one or more displacement data.

7. The method of claim 1, further comprising:
determining that the one or more displacement data is outside of a threshold value; and
causing the processor to display an alarm based on the determining.

8. The method of claim 1, further comprising:
determining oil whip, oil whirl, or both due to presence of oil within the bearing;
causing the processor to display the oil whip, oil whirl, or both.

9. A method for monitoring a shaft in a bearing, comprising:
obtaining a graphical representation of a shaft and a bearing supporting the shaft;
obtaining one or more performance metric data one or more time periods from a pair of displacement sensor and a tachometer sensor coupled to the bearing; and
causing a processor to display the graphical representation of the shaft and the bearing on a computer display supplemented by the one or more performance metric data.

10. The method of claim 9, further comprising:
obtaining one or more speed data representative of a speed at which the shaft is rotating from the tachometer sensor; and
causing the processor to display the graphical representation of the shaft and the bearing on the computer display supplemented by the one or more speed data.

11. The method of claim 9, further comprising creating the graphical representation of the shaft and the bearing.

12. The method of claim 9, wherein the one or more performance metric data comprises one or more of: displacement data representative of a position of the shaft relative to the bearing at the one or more time periods; speed data, acceleration data, harmonic data, and combinations thereof.

13. The method of claim 13, further comprising determining one or more performance metric data based on the one or more displacement data.

14. The method of claim 12, further comprising creating an orbital plot for the shaft based on the one or more displacement data.

15. The method of claim 12, further comprising:
determining that the one or more displacement data is outside of a threshold value; and
causing the processor to display an alarm based on the determining.

16. The method of claim 9, further comprising:
determining oil whip, oil whirl, or both due to presence of oil within the bearing;
causing the processor to display the oil whip, oil whirl, or both.
